(19) United States
(12) Patent Application Publication
(10) Pub. No.: US 2021/0409592 A1
(43) Pub. Date: Dec. 30, 2021

(54) OBJECT DETECTION DEVICE, SYSTEM, METHOD, AND RECORDING MEDIUM

(71) Applicant: NEC Corporation, Minato-ku, Tokyo (JP)

(72) Inventor: Yasunori NISHIKAWA, Tokyo (JP)

(73) Assignee: NEC Corporation, Minato-ku, Tokyo (JP)

(21) Appl. No.: 17/288,993

(22) PCT Filed: Oct. 30, 2019
(86) PCT No.: PCT/JP2019/042557

§ 371 Date: Apr. 27, 2021

(30) Foreign Application Priority Data
Nov. 7, 2018 (JP) 2018-209736

(51) Int. Cl. H04N 5/232; G06K 9/00; G06T 7/70

(52) U.S. Cl. CPC H04N 5/23219; G06K 9/00771; G06T 2207/30242; H04N 5/23296; H04N 5/23299; G06T 7/70

(57) ABSTRACT

A first image captured is received, a second image captured by a second imaging device is received, detection of an object captured in the first image and the detection of the object captured in the second image are performed, characteristic information of the first image is calculated, learning information that associates the characteristic information, a detection index regarding good or bad of a result of the detection, and range information regarding an imaging range of the second imaging device is stored, a correspondence relation between the characteristic information and the range information for obtaining the better detection index is estimated based on the learning information, and the imaging range of the second imaging device is controlled to become the imaging range indicated by the range information related to the characteristic information in the correspondence relation when the calculated characteristic information corresponds to the characteristic information in the estimated correspondence relation.

### TECHNICAL FIELD

The present invention relates to an object detection device, a system, a method, and a recording medium.

### BACKGROUND ART

It is desirable that surveillance cameras used in environments where many people come and go can detect a larger number of people's faces.

However, when a surveillance camera detects a face, the surveillance camera cannot detect the face in many cases when a captured image does not satisfy a resolution required for face detection, such as when the distance between the surveillance camera and the person is distant. Further, it is also difficult to detect the face when the person is not facing the surveillance camera.

PTL 1 discloses a method of determining a resolution capable of extracting a characteristic amount that enables each of a plurality of objects to be discriminated, and controlling an imaging means to output an image at the determined resolution. This method enables individual objects to be discriminated by controlling the imaging means to increase the resolution.

### CITATION LIST

### Patent Literature

[PTL 1] JP 2017-076909 A

### SUMMARY OF INVENTION

### Technical Problem

However, the method described in PTL 1 increases the resolution in a case where the resolution of the captured image of the person does not satisfy the resolution necessary for discrimination of an individual person although the person is captured in the captured image. This method is not intended to obtain a better detection result such as detecting a larger number of people but to discriminate the persons being detected. Therefore, this method has a possibility of detecting a new person by chance but has a low possibility of detecting a better detection result.

An object of the present invention is to provide an object detection device, a system, a method, and a recording medium for improving a possibility of obtaining a better object detection result.

### Solution to Problem

To solve the above-described problem, in an example embodiment of the present invention, an object detection device includes a first reception means for receiving a first image captured by a first imaging device, a second reception means for receiving a second image captured by a second imaging device; a detection means for performing detection of an object captured in the first image and performing the detection of the object captured in the second image, a characteristic information calculation means for calculating characteristic information indicating a characteristic of the first image, a learning means for causing a storage unit to store learning information that associates the characteristic information, a detection index that is an index regarding good or bad of a result of the detection of the object, and range information regarding an imaging range of the second imaging device, an estimation means for estimating a correspondence relation between the characteristic information and the range information for obtaining the better detection index based on the learning information, and a control means for controlling the imaging range of the second imaging device so as to become the imaging range indicated by the range information related to the characteristic information in the correspondence relation when the calculated characteristic information corresponds to the characteristic information in the estimated correspondence relation.

Further, in another example embodiment of the present invention, an object detection method includes receiving a first image captured by a first imaging device, receiving a second image captured by a second imaging device, performing detection of an object captured in the first image and performing the detection of the object captured in the second image, calculating characteristic information indicating a characteristic of the first image, storing learning information that associates the characteristic information, a detection index that is an index regarding good or bad of a result of the detection of the object, and range information regarding an imaging range of the second imaging device, estimating a correspondence relation between the characteristic information and the range information for obtaining the better detection index based on the learning information, and controlling the imaging range of the second imaging device so as to become the imaging range indicated by the range information related to the characteristic information in the correspondence relation when the calculated characteristic information corresponds to the characteristic information in the estimated correspondence relation.

Further, in another example embodiment of the present invention, a computer-readable recording medium recording an object detection program causes a computer to execute a first reception function to receive a first image captured by a first imaging device, a second reception function to receive a second image captured by a second imaging device, a detection function to perform detection of an object captured in the first image and perform the detection of the object captured in the second image, a characteristic information calculation function to calculate characteristic information indicating a characteristic of the first image, a learning function to cause a storage unit to store learning information that associates the characteristic information, a detection index that is an index regarding good or bad of a result of the detection of the object, and range information regarding an imaging range of the second imaging device, an estimation function to estimate a correspondence relation between the characteristic information and the range information for obtaining the better detection index based on the learning information, and a control function to control the imaging range of the second imaging device so as to become the imaging range indicated by the range information related to the characteristic information in the correspondence relation when the calculated characteristic information corresponds to the characteristic information in the estimated correspondence relation.

### Advantageous Effects of Invention

The object detection device, system, method and recording medium of the present invention can improve the possibility of obtaining a better object detection result.

### BRIEF DESCRIPTION OF DRAWINGS

FIG. 1 shows a configuration example of an object detection device according to a first example embodiment of the present invention.

FIG. 2 shows an operation example of the object detection device according to the first example embodiment of the present invention.

FIG. 3 shows a configuration example of an object detection system according to a second example embodiment of the present invention.

FIG. 4 shows an example of imaging ranges of a first imaging device and a second imaging device according to the second example embodiment of the present invention.

FIG. 5 shows an example of learning information according to the second example embodiment of the present invention.

FIG. 6 shows an operation example of an object detection device according to the second and third example embodiments of the present invention.

FIG. 7 shows an operation example of the object detection device according to the second and third example embodiments of the present invention.

FIG. 8 shows an example of an imaging region of the object detection device according to the third example embodiment of the present invention.

FIG. 9 shows an example of learning information according to the third example embodiment of the present invention.

FIG. 10 shows an example of the learning information according to the third example embodiment of the present invention.

FIG. 11 shows a hardware configuration example of each example embodiment of the present invention.

### EXAMPLE EMBODIMENT

### First Example Embodiment

First, a first example embodiment of the present invention is described.

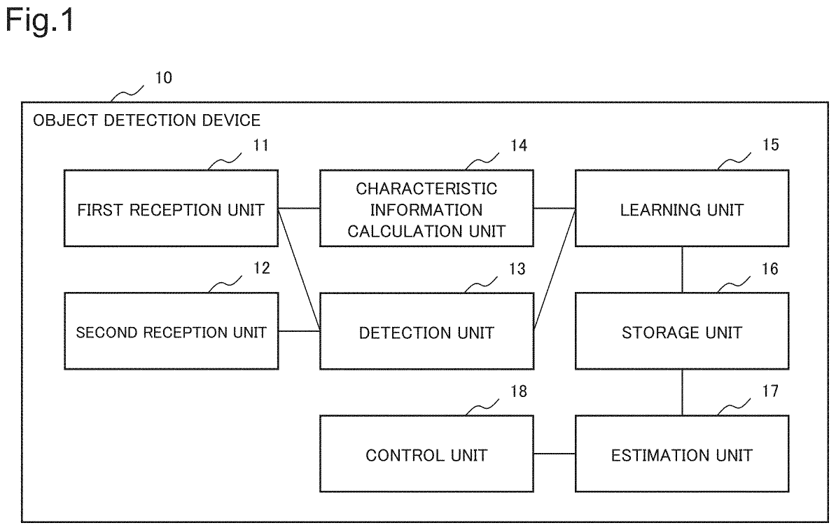

FIG. 1 illustrates a configuration example of an object detection device 10 according to the present example embodiment. The object detection device 10 of the present example embodiment includes a first reception unit 11, a second reception unit 12, a detection unit 13, a characteristic information calculation unit 14, a learning unit 15, a storage unit 16, an estimation unit 17, and a control unit 18.

The first reception unit 11 receives a first image captured by the first imaging device. The second reception unit 12 receives a second image captured by the second imaging device.

The detection unit 13 detects an object captured in the first image and detects an object captured in the second image. The characteristic information calculation unit 14 calculates characteristic information illustrating a characteristic of the first image.

The learning unit 15 causes the storage unit 16 to store learning information that associates the characteristic information, a detection index that is an index regarding good or bad of a result of detection of the object, and range information regarding an imaging range of the second imaging device.

The estimation unit 17 estimates a correspondence relation between the characteristic information and the range information for obtaining a better detection index based on the learning information. When the calculated characteristic information corresponds to the characteristic information in the estimated correspondence relation, the control unit 18 controls the imaging range of the second imaging device so as to be the imaging range indicated by the range information related to the characteristic information in the correspondence relation.

By configuring the object detection device 10 in this manner, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

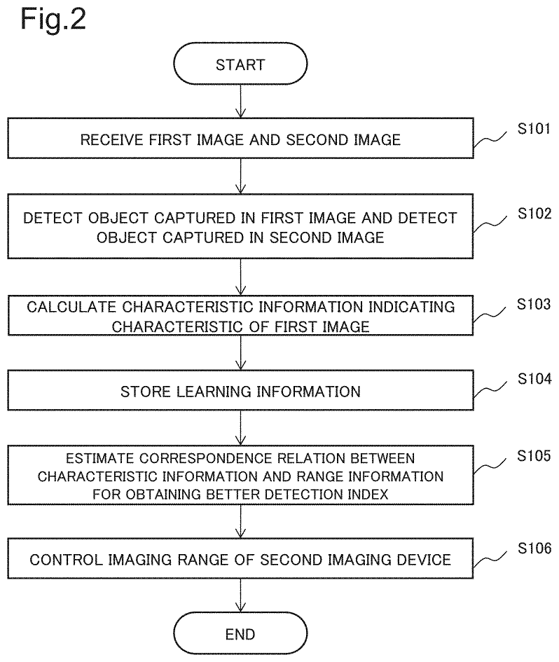

Next, FIG. 2 illustrates an operation example of the object detection device 10 according to the present example embodiment.

The first reception unit 11 receives the first image captured by the first imaging device. The second reception unit 12 receives the second image captured by the second imaging device (step S101).

The detection unit 13 detects an object captured in the first image and detects an object captured in the second image (step S102). The characteristic information calculation unit 14 calculates the characteristic information illustrating a characteristic of the first image (step S103).

The learning unit 15 causes the storage unit 16 to store the learning information that associates the characteristic information, the detection index that is an index regarding good or bad of a result of detection of the object, and the range information regarding the imaging range of the second imaging device (step S104).

The estimation unit 17 estimates a correspondence relation between the characteristic information and the range information for obtaining a better detection index based on the learning information (step S105). Then, when the calculated characteristic information corresponds to the characteristic information in the estimated correspondence relation, the control unit 18 controls the imaging range of the second imaging device so as to be the imaging range indicated by the range information related to the characteristic information in the correspondence relation (step S106).

By operating in this manner, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

As described above, in the first example embodiment of the present invention, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

### Second Example Embodiment

Next, a second example embodiment of the present invention is described. In the present example embodiment, an object detection device 10 is specifically described.

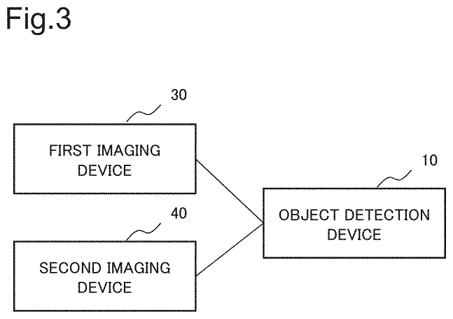

First, FIG. 3 illustrates a configuration example of an object detection system according to the present example embodiment. The object detection system according to the present example embodiment includes the object detection device 10, a first imaging device 30, and a second imaging device 40.

The first imaging device 30 and the second imaging device 40 are imaging devices such as surveillance cameras. In the present example embodiment, the first imaging device 30 is assumed to be a fixed camera capable of wide-angle capture. Further, the second imaging device 40 is assumed to be a camera capable of pan tilt zoom (PTZ) control, that is, control in an imaging direction captured by the second imaging device 40 and zoom magnification control. The first imaging device 30 may also be a camera capable of PTZ control.

The object detection device 10 detects an object (for example, the face of a person) based on a first image captured by the first imaging device 30 and a second image captured by the second imaging device 40. The first imaging device 30 and the second imaging device 40 may be directly connected to the object detection device 10 or indirectly connected to the object detection device 10 via a network or the like.

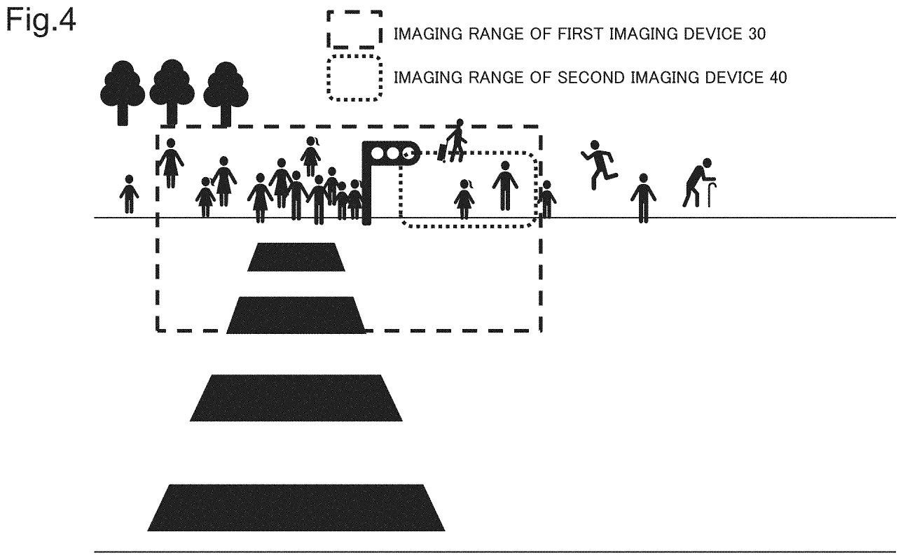

FIG. 4 illustrates an example of an imaging range of the first imaging device 30 and an imaging range of the second imaging device 40. In the present example embodiment, since the first imaging device 30 is a fixed camera capable of wide-angle capture, the imaging range of the first imaging device 30 is fixed. Since the second imaging device 40 is a camera capable of PTZ control, the imaging range of the second imaging device 40 can be changed.

Next, a configuration example of the object detection device 10 according to the present example embodiment is described with reference to FIG. 1.

A first reception unit 11 receives the first image captured by the first imaging device 30. A second reception unit 12 receives the second image captured by the second imaging device 40.

A detection unit 13 detects an object (for example, the face of a person) captured in the first image and detects an object captured in the second image. Any method can be used for detecting an object.

A characteristic information calculation unit 14 calculates characteristic information illustrating a characteristic of the first image. In the present example embodiment, the characteristic information calculation unit 14 uses change information regarding a change in a characteristic amount as the characteristic information. More specifically, the characteristic information calculation unit 14 specifies a change portion of the first image in which the characteristic amount has changed based on the first image, calculates a change amount in the characteristic amount in the change portion, and uses information of the change portion and the change amount as characteristic information.

The characteristic amount is, for example, a value indicating color. For example, when the color of a signal changes, the characteristic information calculation unit 14 calculates the change amount in the color of the signal, using the portion of the signal as the change portion. The characteristic amount may be a value indicating a sound (in a case of receiving the sound from the first imaging device 30), a value indicating brightness, or the like. The characteristic information calculation unit 14 can specify the change portion and calculate the change amount for one or more characteristic amounts.

A learning unit 15 causes a storage unit 16 to store learning information that associates the characteristic information, a detection index that is an index regarding good or bad of a result of detection of an object, and range information regarding the imaging range of the second imaging device 40.

The detection index is an index regarding good or bad of a result of detection of an object performed by the detection unit 13. The detection index is, for example, the number of objects detected based on the second image. Alternatively, the detection index may be a number obtained by subtracting the number of objects detected from both the first image and the second image from the number of objects detected from the second image. Alternatively, the detection index may be a value (average value or the like) regarding faciality of a detected object, the number of detected objects among objects registered as objects to be detected in advance, a value regarding a change in the characteristic amount of the second image, or the like.

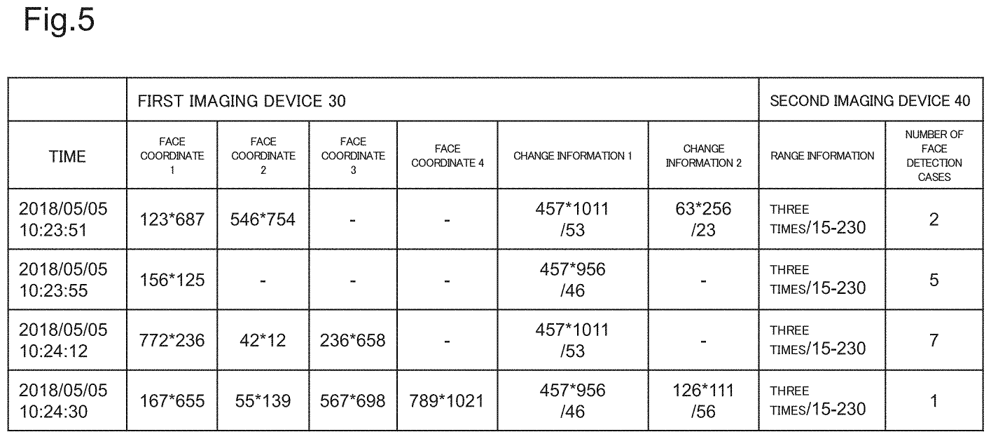

FIG. 5 illustrates an example of the learning information that the learning unit 15 causes the storage unit 16 to store. A face coordinate and the change information are information regarding the first image captured by the first imaging device 30, and the range information and the number of face detection cases are information regarding the second image captured by the second imaging device 40.

The face coordinate is information of the coordinate in the first image, of the face detected from the first image captured by the first imaging device 30. In this example, four face coordinates are stored, but the number of face coordinates stored as the learning information is optional. Further, the characteristic information calculation unit 14 can store an age estimation value and a gender estimation value in addition to the face coordinates in the learning unit 15.

The change information is information of the change portion and the change amount in the change portion. In the example of FIG. 5, the left side of “/” indicates coordinate information of the change portion, and the right side of “/” indicates the change amount. In this example, two pieces of change information are stored at each time, but the number of pieces of change information stored as the learning information is optional.

The range information is information regarding the imaging range of the second imaging device 40. In this example, the left side of “/” indicates the zoom magnification, and the right side of “/” indicates the imaging direction (tilt angle—pan angle).

The number of face detection cases is the number of faces detected from the second image captured by the second imaging device 40. In this example, the number of face detection cases in the second image is used as the detection index.

The estimation unit 17 estimates a correspondence relation between the characteristic information and the range information for obtaining a better detection index based on the learning information. For example, in a case where the detection index is the number of faces detected from the second image, the estimation unit 17 estimates the correspondence relation between the characteristic information (the change information in the present example embodiment) and the range information in which the number of faces detected from the second image becomes larger. The characteristic information calculation unit 14 can estimate the correspondence relation by machine learning. Any method can be used for the machine learning method.

When the characteristic information calculated by the characteristic information calculation unit 14 corresponds to the characteristic information in the estimated correspondence relation estimated by the learning unit 15, the control unit 18 controls the imaging range of the second imaging device so as to be the imaging range indicated by the range information related to the characteristic information in the correspondence relation.

For example, it is assumed that the estimation unit 17 estimates a pair of the change information of “the color of a signal changes from blue to red” and the range information of “three-time zoom in a lower right direction” as the correspondence relation for obtaining a better detection index. In this case, when the change information calculated by the characteristic information calculation unit 14 is “the color of a signal changes from blue to red”, a control unit 18 directs the imaging direction of the second imaging device 40 to the lower right and increases the zoom magnification by three times.

Further, the control unit 18 changes the imaging range of the second imaging device 40 according to a predetermined rule (random or the like) at predetermined timing. The predetermined timing is, for example, until a predetermined amount of the learning information is stored in the storage unit 16 or during a predetermined period of time. The control unit 18 can control the imaging range of the second imaging device 40 by using an open network video interface forum (ONVIF) interface or the like.

By configuring the object detection device 10 in this manner, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

Further, the object detection device 10 of the present example embodiment uses the change information as the characteristic information. Thereby, the object detection device 10 can control the second imaging device 40 at timing when a person is likely to face a specific direction, such as a change in the color of a signal. Therefore, the object detection device 10 can obtain a better object detection result.

The object detection device 10 of the present example embodiment estimates a correspondence relation between the characteristic information and the imaging range for obtaining a better detection index based on learning information. Therefore, the object detection device 10 can automatically respond to a change in an external environment (new Installation of a building, or the like).

Further, the object detection system of the present example embodiment uses an imaging device capable of wide-angle capture and an imaging device capable of changing an imaging range. Therefore, the object detection system can obtain a better object detection result without changing the imaging device to one capable of wide-angle capture and having a high resolution.

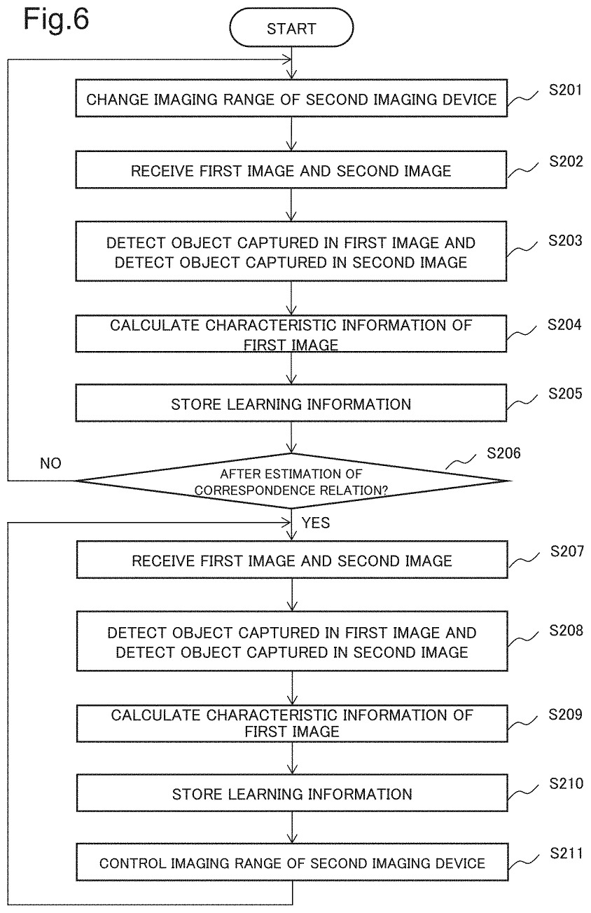

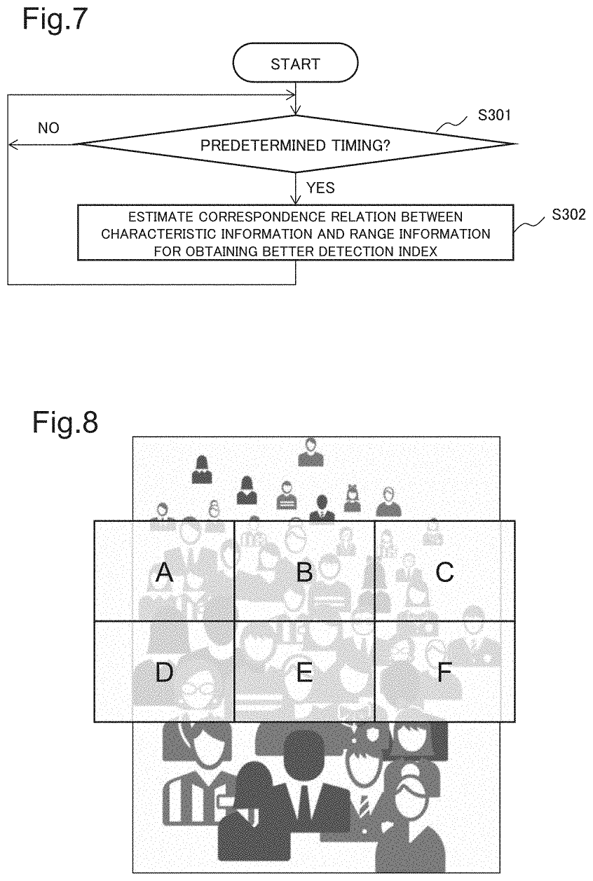

Next, FIGS. 6 and 7 illustrate an operation example of the object detection device 10 according to the present example embodiment.

First, the object detection device 10 changes the imaging range of the second imaging device 40 according to a predetermined rule (random or the like) (step S201 of FIG. 6).

Next, the object detection device 10 receives the first image from the first imaging device 30 and the second image from the second imaging device 40 (step S202). Then, the object detection device 10 detects an object captured in the first image and detects an object captured in the second image (step S203).

Further, the object detection device 10 calculates the characteristic information indicating a characteristic of the first image, for example, the change information regarding a change in the characteristic amount, based on the first image captured by the first imaging device 30 (step S204).

Next, the object detection device 10 causes the storage unit 16 to store the learning information that associates the characteristic information (for example, the change information), the detection index, and the range information regarding the imaging range of the second imaging device 40 (step S205).

Then, the object detection device 10 repeats the operations of steps S201 to S205 of FIG. 6 until the correspondence relation is estimated in step S302 of FIG. 7 (NO in step S206).

The object detection device 10 estimates, at predetermined timing (YES in step S301), the correspondence relation between the characteristic information and the range information for obtaining a better detection index based on the learning information stored in the storage unit 16 (step S302). The predetermined timing is, for example, optional timing such as timing at which a predetermined amount of the learning information is stored in the storage unit 16 or predetermined time interval.

After the correspondence relation is estimated (YES in step S206), reception of the first image and the second image, detection of objects, calculation of the characteristic information, and storage of the learning information are performed (steps S207 to S210), similarly to steps S202 to S205.

Then, when the calculated characteristic information corresponds to the characteristic information in the estimated correspondence relation, the object detection device 10 controls the imaging range of the second imaging device 40 so as to be the imaging range indicated by the range information related to the characteristic information in the correspondence relation (step S211).

Thereafter, the object detection device 10 repeats the operations of steps S207 to S211. Further, the object detection device 10 estimates a new correspondence relation (step S302) at predetermined timing (YES in step 301). In step S211, the object detection device 10 controls the imaging range of the second imaging device 40 based on the latest correspondence relation. The object detection device 10 may repeat steps S201 to S205 of FIG. 6 for predetermined period of time before estimating the correspondence relation in the second time and onward.

By operating in this manner, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

As described above, in the second example embodiment of the present invention, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

Further, the object detection device 10 of the present example embodiment uses the change information as the characteristic information. Thereby, the object detection device 10 can control the second imaging device 40 at timing when a person is likely to face a specific direction, such as a change in the color of a signal. Therefore, the object detection device 10 can obtain a better object detection result.

The object detection device 10 of the present example embodiment estimates a correspondence relation between the characteristic information and the imaging range for obtaining a better detection index based on learning information. Therefore, the object detection device 10 can automatically respond to a change in an external environment (new Installation of a building, or the like).

Further, the object detection system of the present example embodiment uses an imaging device capable of wide-angle capture and an imaging device capable of changing an imaging range. Therefore, the object detection system can obtain a better object detection result without changing the imaging device to one capable of wide-angle capture and having a high resolution.

### Third Example Embodiment

Next, a third example embodiment of the present invention is described. In the present example embodiment, a case of using the number of objects detected from a first image captured by a first imaging device 30 as characteristic amount is described.

First, a configuration example of an object detection device 10 according to the present example embodiment is described with reference to FIG. 1.

A characteristic information calculation unit 14 of the present example embodiment uses information regarding the number of objects detected from the first image as characteristic information of the first image. More specifically, for example, the object detection device 10 divides the first image into several predetermined regions and uses the number of objects for each region as the characteristic information.

FIG. 8 illustrates an example of a region obtained by dividing an imaging range of the first imaging device 30. In this example, to simplify the description, the imaging range of the first imaging device 30 is divided into six regions. Any number/shape can be used for the number/shape of regions.

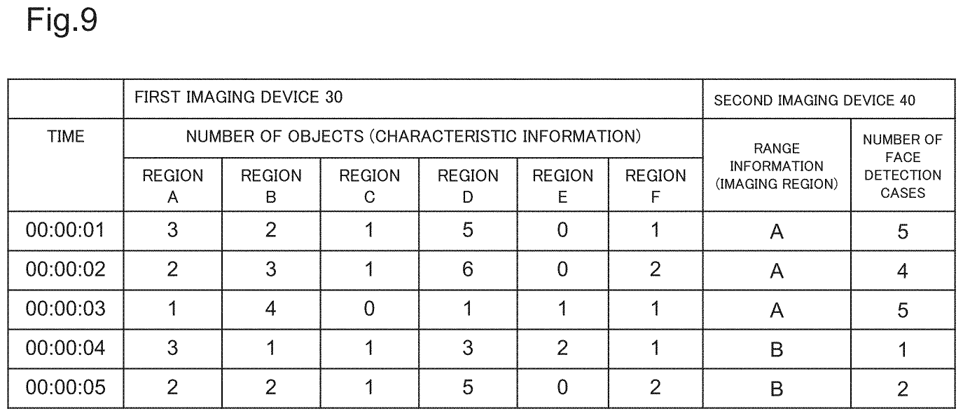

FIG. 9 illustrates an example of learning information that a learning unit 15 causes a storage unit 16 to store. In this example, the number of objects detected in each of the regions in FIG. 8 is used as the characteristic information of the first image. Further, the information of the regions illustrated in FIG. 8 is used as information of an imaging range captured by a second imaging device 40.

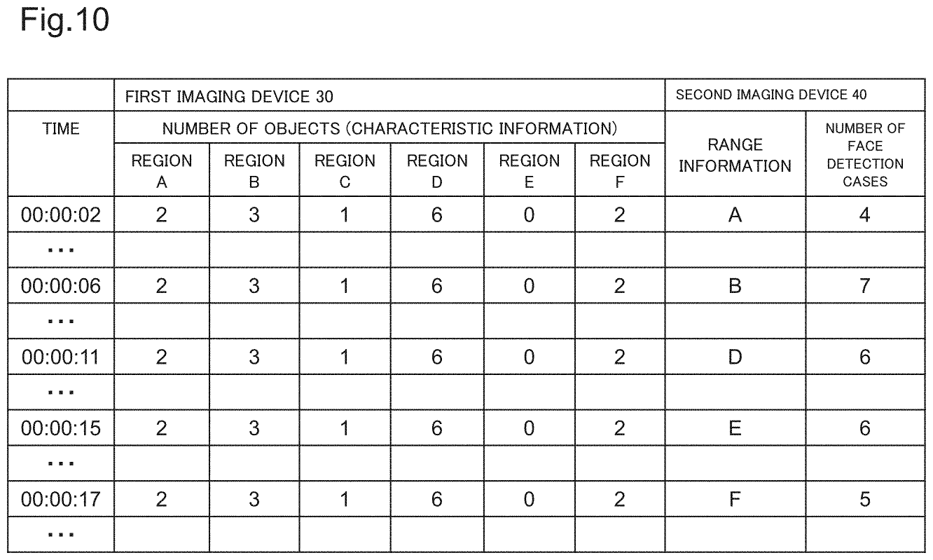

Then, an estimation unit 17 estimates a correspondence relation between the characteristic information and range information for obtaining a better detection index by machine learning based on the learning information stored in the storage unit 16. In the case where the learning information as illustrated in FIG. 10 is stored in the storage unit 16, the estimation unit 17 estimates a correspondence relation between the characteristic information and the range information (imaging region) in which the number of objects detected from the second image becomes larger. In this example, the object detection device 10 estimates a correspondence relation in which the region B having the largest number of face detection cases is associated with the characteristic information in which the numbers of objects detected from the first image are 2, 3, 1, 6, 0, and 2 in the respective regions A to F. Then, the control unit 18 controls the second imaging device 40 such that the imaging range of the second imaging device 40 becomes the region B when the numbers of objects detected from the first image become 2, 3, 1, 6, 0, and 2 in the respective regions A to F.

Since the other parts are similar to those of the second example embodiment, description is omitted.

By configuring the object detection device 10 in this manner, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

Since an operation example of the object detection device 10 of the present example embodiment is similar to the operation example of the object detection device 10 of the second example embodiment (FIGS. 6 and 7), description thereof is omitted.

As described above, in the third example embodiment of the present invention, the object detection device 10 detects the object captured in the second image and calculates the characteristic information of the first image. Further, the learning information that associates the characteristic information, the detection index that is an index regarding good or bad of a result of detection of the object, and the range information regarding the imaging range of the second imaging device is stored, and the correspondence relation between the characteristic information and the range information for obtaining a better detection index is estimated based on the learning information. Then, when the calculated characteristic information corresponds to the characteristic information in the estimated correspondence relation, the object detection device 10 controls the imaging range of the second imaging device so as to be the imaging range indicated by the range information related to the characteristic information in the correspondence relation. Thereby, the object detection device 10 can control the imaging range of the second imaging device 40 so as to be the imaging range estimated to obtain a better detection index. Therefore, the possibility of obtaining a better object detection result can be improved.

### Hardware Configuration Example

A configuration example of hardware resources for implementing the object detection device (10) in each of the above-described example embodiments of the present invention using one information processing device (computer) is described. Note that the object detection device may be implemented physically or functionally using at least two information processing devices. Further, the object detection device may be implemented as a dedicated device. Further, only a part of the functions of the object detection device may be implemented using an information processing device.

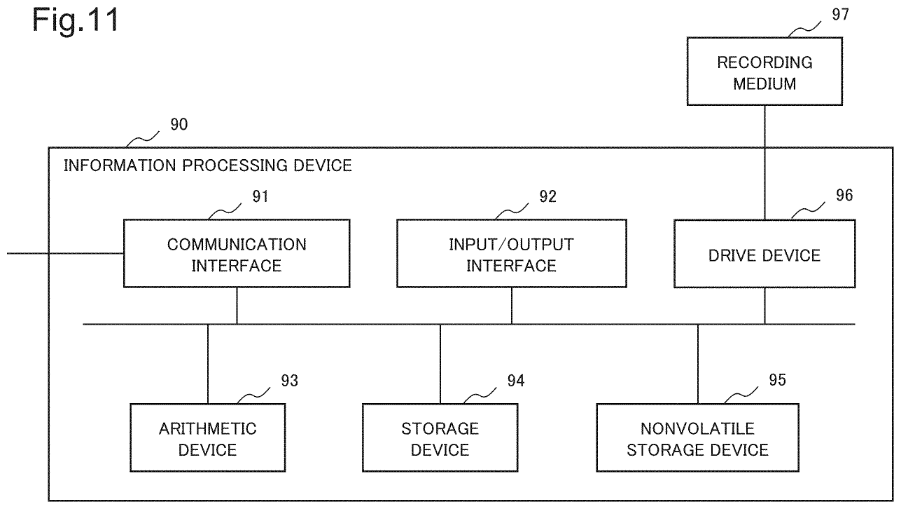

FIG. 11 is a diagram schematically illustrating a hardware configuration example of an information processing device capable of implementing the object detection device according to each example embodiment of the present invention. An information processing device 90 includes a communication interface 91, an input/output interface 92, an arithmetic device 93, a storage device 94, a nonvolatile storage device 95, and a drive device 96.

The communication interface 91 is a communication means for the object detection device of each example embodiment to communicate with an external device by wired or/and wireless means. In the case of implementing the object detection device using at least two information processing devices, the information processing devices may be connected to be able to communicate with each other via the communication interface 91.

The input/output interface 92 is a man-machine interface such as a keyboard as an example of an input device or a display as an output device.

The arithmetic device 93 is an arithmetic processing device such as a general-purpose central processing unit (CPU) or a microprocessor. The arithmetic device 93 can read various programs stored in the nonvolatile storage device 95 into the storage device 94 and execute processing according to the read programs, for example.

The storage device 94 is a memory device such as a random access memory (RAM), which can be referred to from the arithmetic device 93, and stores programs and various data. The storage device 94 may be a volatile memory device.

The nonvolatile storage device 95 is a nonvolatile storage device such as a read only memory (ROM) or a flash memory, and can store various programs, data, and the like.

The drive device 96 is, for example, a device that reads and writes data to and from the recording medium 97, which is described below.

The recording medium 97 is, for example, an optional recording medium capable of recording data, such as an optical disk, a magneto-optical disk, or a semiconductor flash memory.

Each example embodiment of the present invention may be implemented by, for example, configuring the object detection device with the information processing device 90 illustrated in FIG. 11, and supplying a program capable of implementing the functions described in the each example embodiment to the object detection device.

In this case, the example embodiment can be implemented by the arithmetic device 93 executing the program supplied to the object detection device. Further, not all of the functions but some of the functions of the object detection device can be configured by the information processing device 90.

Further, the program may be recorded on the recording medium 97, and the program may be stored in the nonvolatile storage device 95 as appropriate at a shipping stage, an operation stage, or the like of the object detection device. In this case, a method of supplying the program may be a method of installing the program in the object detection device using an appropriate jig in a manufacturing stage before shipment or the operation stage. Further, as the method of supplying the program, a general procedure such as a method of downloading the program from an outside via a communication line such as the Internet may be adopted.

Some or all of the above-described example embodiments can be described as but are not limited to supplementary notes below.

### Supplementary Note 1

An object detection device comprising:

a first reception means for receiving a first image captured by a first imaging device;

a second reception means for receiving a second image captured by a second imaging device;

a detection means for performing detection of an object captured in the first image and performing the detection of the object captured in the second image;

a characteristic information calculation means for calculating characteristic information indicating a characteristic of the first image;

a learning means for causing a storage unit to store learning information that associates the characteristic information, a detection index that is an index regarding good or bad of a result of the detection of the object, and range information regarding an imaging range of the second imaging device;

an estimation means for estimating a correspondence relation between the characteristic information and the range information for obtaining the better detection index based on the learning information; and

a control means for controlling the imaging range of the second imaging device so as to become the imaging range indicated by the range information related to the characteristic information in the correspondence relation when the calculated characteristic information corresponds to the characteristic information in the estimated correspondence relation.

### Supplementary Note 2

The object detection device according to supplementary note 1, in which

the characteristic information includes change information regarding a change in a characteristic amount.

### Supplementary Note 3

The object detection device according to supplementary note 2, in which

the characteristic amount is a value regarding one or more of color, brightness, and sound received from the first imaging device.

### Supplementary Note 4

The object detection device according to any one of supplementary notes 1 to 3, in which

the characteristic information includes information regarding the number of the objects detected from the first image.

### Supplementary Note 5

The object detection device according to any one of supplementary notes 1 to 4, in which

the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

### Supplementary Note 6

The object detection device according to any one of supplementary notes 1 to 5, in which

the control means performs the control of the imaging range by changing an imaging direction and a zoom magnification of the second imaging device.

### Supplementary Note 7

The object detection device according to any one of supplementary notes 1 to 6, in which

the control means performs the control of the imaging range of the second imaging device according to a predetermined rule until the estimation of the correspondence relation is performed, and performs the control of the imaging range of the second imaging device according to the correspondence relation after the estimation of the correspondence relation is performed.

### Supplementary Note 8

An object detection system comprising:

the object detection device according to any one of supplementary notes 1 to 7;

the first imaging device; and

the second imaging device.

### Supplementary Note 9

An object detection method comprising:

receiving a first image captured by a first imaging device;

receiving a second image captured by a second imaging device;

performing detection of an object captured in the first image and performing the detection of the object captured in the second image;

calculating characteristic information indicating a characteristic of the first image;

storing learning information that associates the characteristic information, a detection index that is an index regarding good or bad of a result of the detection of the object, and range information regarding an imaging range of the second imaging device;

estimating a correspondence relation between the characteristic information and the range information for obtaining the better detection index based on the learning information; and

controlling the imaging range of the second imaging device so as to become the imaging range indicated by the range information related to the characteristic information in the correspondence relation when the calculated characteristic information corresponds to the characteristic information in the estimated correspondence relation.

### Supplementary Note 10

The object detection method according to supplementary note 9, in which

the characteristic information includes change information regarding a change in a characteristic amount.

### Supplementary Note 11

The object detection method according to supplementary note 10, in which

the characteristic amount is a value regarding one or more of color, brightness, and sound received from the first imaging device.

### Supplementary Note 12

The object detection method according to any one of supplementary notes 9 to 11, in which

the characteristic information includes information regarding the number of the objects detected from the first image.

### Supplementary Note 13

The object detection method according to any one of supplementary notes 9 to 12, in which

the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

### Supplementary Note 14

The object detection method according to any one of supplementary notes 9 to 13, in which

the control of the imaging range is performed by changing an imaging direction and a zoom magnification of the second imaging device.

### Supplementary Note 15

The object detection method according to any one of supplementary notes 9 to 14, in which

the control of the imaging range of the second imaging device is performed according to a predetermined rule until the estimation of the correspondence relation is performed, and the control of the imaging range of the second imaging device is performed according to the correspondence relation after the estimation of the correspondence relation is performed.

### Supplementary Note 16

A computer-readable recording medium recording an object detection program for causing a computer to execute:

a first reception function to receive a first image captured by a first imaging device;

a second reception function to receive a second image captured by a second imaging device;

a detection function to perform detection of an object captured in the first image and perform the detection of the object captured in the second image;

a characteristic information calculation function to calculate characteristic information indicating a characteristic of the first image;

a learning function to cause a storage unit to store learning information that associates the characteristic information, a detection index that is an index regarding good or bad of a result of the detection of the object, and range information regarding an imaging range of the second imaging device;

an estimation function to estimate a correspondence relation between the characteristic information and the range information for obtaining the better detection index based on the learning information; and

a control function to control the imaging range of the second imaging device so as to become the imaging range indicated by the range information related to the characteristic information in the correspondence relation when the calculated characteristic information corresponds to the characteristic information in the estimated correspondence relation.

### Supplementary Note 17

The computer-readable recording medium recording an object detection program according to supplementary note 16, in which

the characteristic information includes change information regarding a change in a characteristic amount.

### Supplementary Note 18

The computer-readable recording medium recording an object detection program according to supplementary note 17, in which

the characteristic amount is a value regarding one or more of color, brightness, and sound received from the first imaging device.

### Supplementary Note 19

The computer-readable recording medium recording an object detection program according to any one of supplementary notes 16 to 18, in which

the characteristic information includes information regarding the number of the objects detected from the first image.

### Supplementary Note 20

The computer-readable recording medium recording an object detection program according to any one of supplementary notes 16 to 19, in which

the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

### Supplementary Note 21

The computer-readable recording medium recording an object detection program according to any one of supplementary notes 16 to 20, in which

the control function performs the control of the imaging range by changing an imaging direction and a zoom magnification of the second imaging device.

### Supplementary Note 22

The computer-readable recording medium recording an object detection program according to any one of supplementary notes 16 to 21, in which

the control function performs the control of the imaging range of the second imaging device according to a predetermined rule until the estimation of the correspondence relation is performed, and performs the control of the imaging range of the second imaging device according to the correspondence relation after the estimation of the correspondence relation is performed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-209736, filed on Nov. 7, 2018, the disclosure of which is incorporated herein in its entirety by reference.

### REFERENCE SIGNS LIST

10 object detection device

11 first reception unit

12 second reception unit

13 detection unit

14 characteristic information calculation unit

15 learning unit

16 storage unit

17 estimation unit

18 control unit

30 first imaging device

40 second imaging device

90 information processing device

91 communication interface

92 input/output interface

93 arithmetic device

94 storage device

95 nonvolatile storage device

96 drive device

97 recording medium

What is claimed is:

1. An object detection device comprising one or more memories storing instructions and one or more processors configured to execute the instructions to:
receive a first image captured by a first imaging device;
receive a second image captured by a second imaging device;
perform detection of an object captured in the first image and performing the detection of the object captured in the second image;
calculate characteristic information indicating a characteristic of the first image;
cause a storage unit to store learning information that associates the characteristic information, a detection index that is an index regarding good or bad of a result of the detection of the object, and range information regarding an imaging range of the second imaging device;
estimate a correspondence relation between the characteristic information and the range information for obtaining the better detection index based on the learning information; and
control the imaging range of the second imaging device so as to become the imaging range indicated by the range information related to the characteristic information in the correspondence relation when the calculated characteristic information corresponds to the characteristic information in the estimated correspondence relation.

2. The object detection device according to claim 1, wherein
the characteristic information includes change information regarding a change in a characteristic amount.

3. The object detection device according to claim 2, wherein
the characteristic amount is a value regarding one or more of color, brightness, and sound received from the first imaging device.

4. The object detection device according to claim 1, wherein
the characteristic information includes information regarding the number of the objects detected from the first image.

5. The object detection device according to claim 1, wherein
the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

6. The object detection device according to claim 1, wherein the one or more processors are configured to execute the instructions to
perform the control of the imaging range by changing an imaging direction and a zoom magnification of the second imaging device.

7. The object detection device according to claim 1, wherein the one or more processors are configured to execute the instructions to
perform the control of the imaging range of the second imaging device according to a predetermined rule until the estimation of the correspondence relation is performed, and perform the control of the imaging range of the second imaging device according to the correspondence relation after the estimation of the correspondence relation is performed.

8. An object detection system comprising:
the object detection device according to claim 1;
the first imaging device; and
the second imaging device.

9. An object detection method comprising:
receiving a first image captured by a first imaging device;
receiving a second image captured by a second imaging device;
performing detection of an object captured in the first image and performing the detection of the object captured in the second image;
calculating characteristic information indicating a characteristic of the first image;
storing learning information that associates the characteristic information, a detection index that is an index regarding good or bad of a result of the detection of the object, and range information regarding an imaging range of the second imaging device;
estimating a correspondence relation between the characteristic information and the range information for obtaining the better detection index based on the learning information; and
controlling the imaging range of the second imaging device so as to become the imaging range indicated by the range information related to the characteristic information in the correspondence relation when the calculated characteristic information corresponds to the characteristic information in the estimated correspondence relation.

10. The object detection method according to claim 9, wherein
the characteristic information includes change information regarding a change in a characteristic amount.

11. The object detection method according to claim 10, wherein
the characteristic amount is a value regarding one or more of color, brightness, and sound received from the first imaging device.

12. The object detection method according to claim 9, wherein
the characteristic information includes information regarding the number of the objects detected from the first image.

13. The object detection method according to claim 9, wherein
the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

14. The object detection method according to claim 9, wherein
the control of the imaging range is performed by changing an imaging direction and a zoom magnification of the second imaging device.

15. The object detection method according to claim 9, wherein
the control of the imaging range of the second imaging device is performed according to a predetermined rule until the estimation of the correspondence relation is performed, and the control of the imaging range of the second imaging device is performed according to the correspondence relation after the estimation of the correspondence relation is performed.

16. A non-transitory computer-readable recording medium recording an object detection program for causing a computer to execute:
a first reception function to receive a first image captured by a first imaging device;
a second reception function to receive a second image captured by a second imaging device;
a detection function to perform detection of an object captured in the first image and perform the detection of the object captured in the second image;
a characteristic information calculation function to calculate characteristic information indicating a characteristic of the first image;
a learning function to cause a storage unit to store learning information that associates the characteristic information, a detection index that is an index regarding good or bad of a result of the detection of the object, and range information regarding an imaging range of the second imaging device;
an estimation function to estimate a correspondence relation between the characteristic information and the range information for obtaining the better detection index based on the learning information; and
a control function to control the imaging range of the second imaging device so as to become the imaging range indicated by the range information related to the characteristic information in the correspondence relation when the calculated characteristic information corresponds to the characteristic information in the estimated correspondence relation.

17. The non-transitory computer-readable recording medium recording an object detection program according to claim 16, wherein
the characteristic information includes change information regarding a change in a characteristic amount.

18. The non-transitory computer-readable recording medium recording an object detection program according to claim 17, wherein
the characteristic amount is a value regarding one or more of color, brightness, and sound received from the first imaging device.

19. The non-transitory computer-readable recording medium recording an object detection program according to claim 16, wherein
the characteristic information includes information regarding the number of the objects detected from the first image.

20. The non-transitory computer-readable recording medium recording an object detection program according to claim 16, wherein
the detection index is a value regarding one or more of a value regarding the number of the objects detected based on the second image, a value regarding faciality of the detected object, a value regarding the number of the detected objects among the objects registered as objects to be detected in advance, and a value regarding a change in a characteristic amount of the second image.

21-22. (canceled)
